(19) United States
(12) Patent Application Publication
(10) Pub. No.: US 2011/0019142 A1
(43) Pub. Date: Jan. 27, 2011

(54) DISPLAY DEVICE AND ELECTRONIC APPARATUS

(76) Inventors: Yuichi Inoue, Kanagawa (JP); Ryo Ogawa, Tokyo (JP); Shunichi Suwa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/839,691

(22) Filed: Jul. 20, 2010

(30) Foreign Application Priority Data
Jul. 27, 2009 (JP) P2009-173899

(51) Int. Cl. G02F 1/1343

(52) U.S. Cl. 349/139

(57) ABSTRACT

A display device includes a pixel unit including a plurality of sub-pixels; a plurality of pixel electrodes disposed in the pixel unit so as to correspond to the plurality of sub-pixels; a scanning line disposed at a position between two adjacent pixel electrodes of the plurality of pixel electrodes; and two selecting devices configured to select whether a signal is supplied to the respective two pixel electrodes, the selecting devices being disposed on the scanning line.

### BACKGROUND OF THE INVENTION

1. Field of the Invention

The present invention relates to a display device and an electronic apparatus, and particularly to a display device and an electronic apparatus configured to drive a single pixel unit with a plurality of sub-pixels.

2. Description of the Related Art

In recent years, display devices that use vertical alignment (VA) mode liquid crystal have undergone multi-domain alignment to achieve a wide viewing angle. Japanese Unexamined Patent Application Publication No. 2006-189610 discloses a configuration in which a plurality of sub-pixel electrodes are disposed as pixel electrodes in a single pixel unit and the single pixel unit is driven with the plurality of sub-pixel electrodes.

### SUMMARY OF THE INVENTION

In recent display devices, double-speed driving has become the mainstream to improve moving-image quality. Thus, there has been proposed a configuration in which two thin film transistors (TFTs) are disposed in a single pixel. In the case where drain wiring lines are routed from gate electrodes of the TFTs, if both the drain wiring lines are routed in the same direction from a gate bus line to a plurality of sub-pixel electrodes, the size of a region shielded from the light is increased in the pixel due to the drain wiring line (metal), which decreases the aperture ratio of the pixel. Furthermore, by increasing the length of the drain wiring line, the parasitic capacitance generated between the drain wiring line and a wiring line (e.g., gate electrode) facing the drain wiring line is increased.

It is desirable to suppress a decrease in the aperture ratio of a pixel and decrease parasitic capacitance in a configuration in which a plurality of sub-pixels are included in a single pixel.

According to an embodiment of the present invention, there is provided a display device including a pixel unit including a plurality of sub-pixels; a plurality of pixel electrodes disposed in the pixel unit so as to correspond to the plurality of sub-pixels; a scanning line disposed at a position between two adjacent pixel electrodes of the plurality of pixel electrodes; and two selecting devices configured to select whether a signal is supplied to the respective two pixel electrodes, the selecting devices being disposed on the scanning line. There is also provided an electronic apparatus including the display device in the casing thereof.

In such an embodiment of the present invention, a scanning line is disposed at a position between pixel electrodes of two adjacent sub-pixels in a pixel unit, whereby the distance of a wiring line routed from the scanning line to each of the pixel electrodes can be decreased compared with the case where the scanning line is disposed in an end portion of the pixel unit.

A thin film transistor including a gate electrode, a source electrode, and a drain electrode is used as the selecting device. In the two selecting devices disposed so as to correspond to the two pixel electrodes, the gate electrodes may be connected to the scanning line. The source electrodes may be connected to respective signal lines. The drain electrodes may be connected to wiring lines routed to the substantially central portions of the respective pixel electrodes.

An example of the display device according to an embodiment of the present invention is a liquid crystal display device in which liquid crystal is driven by pixel electrodes. In the case where the display device according to an embodiment of the present invention is such a liquid crystal display device, the wiring lines may each include a portion that extends in a direction different from a transmission axis direction or an absorption axis direction of a polarizing plate of the liquid crystal, in a region where the scanning line is disposed or a light-shielding film is formed. This suppresses the parasitic capacitance generated between the scanning line and the wiring lines.

In the case where the display device according to an embodiment of the present invention is such a liquid crystal display device, the wiring lines may each include a portion that extends in the transmission axis direction or the absorption axis direction of the polarizing plate of the liquid crystal, in a region where the scanning line is disposed or a light-shielding film is formed. The portion may be disposed so as to extend along a boundary between domains of liquid crystal orientation in the pixel unit. Thus, liquid crystal around the wiring lines is oriented in the transmission axis direction or the absorption axis direction of the polarizing plate, which can suppress light leakage.

According to an embodiment of the present invention, a decrease in the aperture ratio of a pixel can be suppressed and the parasitic capacitance can be decreased compared with the case including the configuration in which a plurality of sub-pixels are included in a single pixel but not including the configuration according to an embodiment of the present invention.

### BRIEF DESCRIPTION OF THE DRAWINGS

FIG. 1 shows a configuration example of a circuit of a display device according to an embodiment of the present invention;

FIG. 2 is a schematic sectional view for describing the display device according to an embodiment of the present invention;

FIG. 3 is a schematic plan view for describing a first configuration example of a pixel unit of the display device according to an embodiment of the present invention;

FIG. 4 is a partially enlarged view of a central portion of the first configuration example;

FIG. 5 is a schematic plan view for describing a second configuration example of a pixel unit of the display device according to an embodiment of the present invention;

FIG. 6 is a partially enlarged view of a central portion of the second configuration example;

FIG. 7 is a diagram for describing an example of a pixel electrode (part 1);

FIG. 8 is a diagram for describing an example of a pixel electrode (part 2);

FIG. 9 is a diagram for describing an example of a pixel electrode (part 3);

FIG. 10 is a diagram for describing an example of a pixel electrode (part 4);

FIG. 11 is a diagram for describing an example of a pixel electrode (part 5);

FIG. 12 is a diagram for describing an example of a pixel electrode (part 6);

FIG. 13 is a diagram for describing an example of a pixel electrode (part 7);

FIG. 14 is a perspective view of a television to which an embodiment of the present invention is applied;

FIGS. 15A and 15B are perspective views of a digital camera to which an embodiment of the present invention is applied;

FIG. 16 is a perspective view of a notebook personal computer to which an embodiment of the present invention is applied;

FIG. 17 is a perspective view of a video camera to which an embodiment of the present invention is applied; and

FIGS. 18A to 18G are diagrams showing a mobile terminal apparatus such as a cellular phone to which an embodiment of the present invention is applied.

### DESCRIPTION OF THE PREFERRED EMBODIMENTS

An embodiment of the present invention will now be described. The description is made in the order below.

1. Entire configuration of display device (configuration examples of circuit and section)

2. Configuration of pixel unit (first configuration example and second configuration example)

3. Other examples of pixel electrode

4. Examples of electronic apparatus

### 1. Entire Configuration of Display Device

### Configuration Example of Circuit

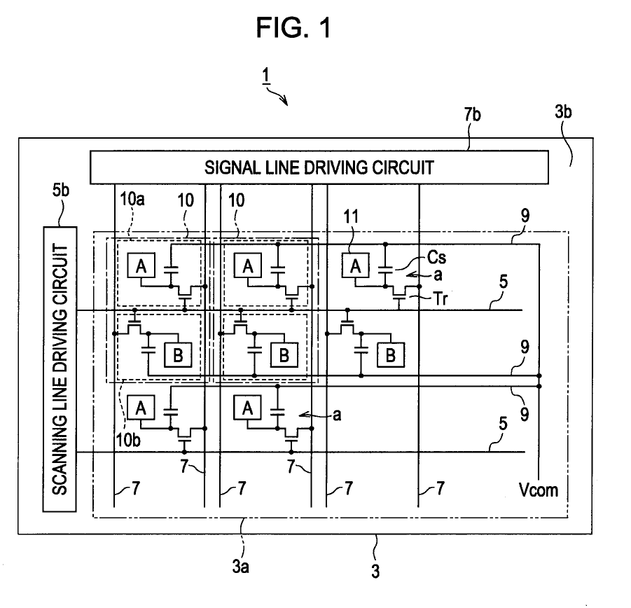

FIG. 1 shows a configuration example of a circuit of a display device according to an embodiment of the present invention. A display device 1 according to an embodiment of the present invention includes a display region 3a and a peripheral region 3b formed on a substrate 3. The display region 3a includes a plurality of scanning lines 5 that extend in a first direction (horizontal direction herein) and a plurality of signal lines 7 that extend in a second direction (vertical direction herein). The display region 3a also includes a plurality of common lines 9, two of which sandwich one of the scanning lines 5. In the display region 3a, there is formed a pixel array portion in which a single pixel unit 10 is disposed so as to correspond to an area defined by one of the scanning lines 5, one of the common lines 9, and two of the signal lines 7. On the other hand, the peripheral region 3b includes a scanning line driving circuit 5b configured to drive the scanning lines 5 through scanning and a signal line driving circuit 7b configured to supply a video signal (input signal) based on brightness information to the signal lines 7.

The pixel unit 10 includes a plurality of sub-pixels. In the example shown in FIG. 1, a single pixel unit 10 includes two sub-pixels 10a and 10b. Each of the sub-pixels 10a and 10b includes a pixel circuit constituted by, for example, a thin film transistor Tr serving as a selecting device and a storage capacitor Cs, and the pixel circuit is connected to a pixel electrode 11. The pixel electrode 11 is disposed so as to correspond to each of the sub-pixels 10a and 10b. In an embodiment of the present invention, the pixel electrode 11 disposed so as to correspond to the sub-pixel 10a is referred to as an A electrode and the pixel electrode 11 disposed so as to correspond to the sub-pixel 10b is referred to as a B electrode. The pixel electrode 11 is disposed on an interlayer insulating film that covers the pixel circuit as specifically described below using a plan view and a sectional view.

The thin film transistor Tr has a gate electrode connected to the scanning line 5, a source electrode connected to the signal line 7, and a drain electrode connected to the pixel electrode 11. The thin film transistor Tr and the common line 9 constitute the storage capacitor Cs. Herein, the thin film transistors Tr of the pixel unit 10 disposed so as to sandwich the scanning line 5 each have a gate electrode connected to the scanning line 5 while sharing the scanning line 5. Another electrode of the storage capacitor Cs is connected to the common line 9. The common line 9 is connected to a common electrode disposed on the counter substrate (not shown) side.

Thus, a video signal voltage written from the signal line 7 is supplied to the pixel electrode 11 through the thin film transistor Tr. At the same time, the same voltage is written into the storage capacitor Cs.

The configuration of the above-described pixel circuit is a mere example. A capacitor element may be optionally disposed in the pixel circuit, and a plurality of transistors may be disposed in the pixel circuit. Furthermore, a necessary driving circuit may be added to the peripheral region 3b when the pixel circuit is changed.

A feature of the display device 1 according to an embodiment of the present invention is that the scanning line 5 is disposed at a position between the A electrode and the B electrode, which are respectively pixel electrodes of the sub-pixels 10a and 10b in a single pixel unit 10. Thus, the distance of a wiring line routed from the scanning line 5 to the center of each of the electrodes A and B through the drain electrode of the thin film transistor Tr can be decreased compared with the case where the scanning line 5 is disposed in an end portion of the pixel unit 10.

### Configuration Example of Section

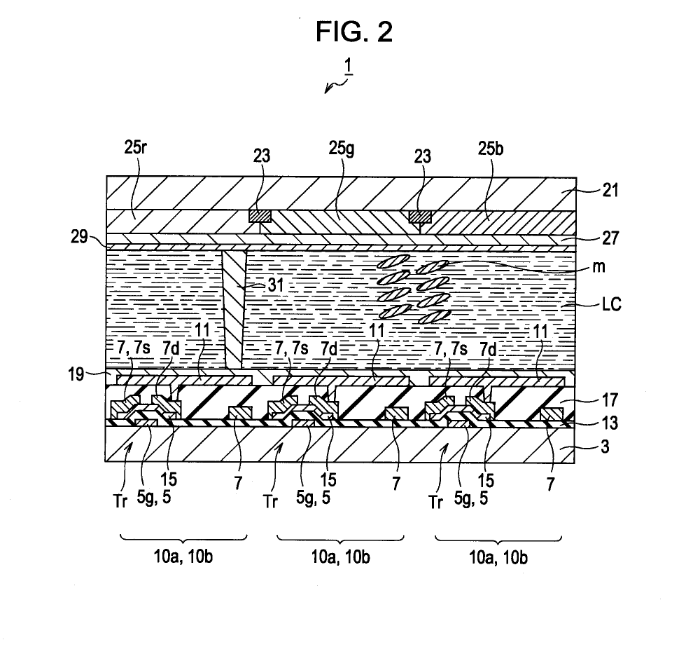

FIG. 2 is a schematic sectional view for describing the display device according to an embodiment of the present invention. FIG. 2 shows a section of a region corresponding to three pairs of sub-pixels 10a and 10b in the display device 1. The display device 1 is a liquid crystal display device including a liquid crystal layer LC interposed between the substrate 3 and a counter substrate 21.

The gate electrode 5g is formed on the substrate 3 as a first-layer wiring line. The gate electrode 5g is made of a conductive material such as aluminum or molybdenum. There is an electrical connection between the gate electrode 5g and the scanning line 5. The common line 9 shown in FIG. 1 is also formed on the substrate 3 as a first-layer wiring line. In the sub-pixels 10a and 10b, the common line 9 is formed as a lower electrode of an auxiliary storage capacitor (Cs) shown in FIG. 1.

A gate insulating film 13 is formed on the gate electrode 5g. A semiconductor layer 15 serving as an active region of the thin film transistor Tr is formed on the gate insulating film 13 so as to correspond to the gate electrode 5g.

The signal line 7 and the source electrode 7s and the drain electrode 7d of the thin film transistor Tr are formed, as second-layer wiring lines, on the gate insulating film 13 having the semiconductor layer 15 formed thereon. The source electrode 7s that extends from the signal line 7 is overlaid on the semiconductor layer 15 in each pixel portion. The signal line 7, the source electrode 7s, and the drain electrode 7d are made of a conductive material such as aluminum or molybdenum.

An insulating film 17 such as a planarizing insulating film is formed so as to cover the semiconductor layer 15, the signal line 7, the source electrode 7s, and the drain electrode 7d.

A pixel electrode 11 made of a transparent conductive material such as indium tin oxide (ITO) is formed on the insulating film 17 as a third-layer wiring line. The pixel electrode 11 is connected to the drain electrode 7d through a connection hole formed in the insulating film 17. The storage capacitor (Cs) shown in FIG. 1 is formed in a portion between the common line 9 serving as a lower electrode and the pixel electrode 11 formed above the common line 9.

The pixel electrode 11 is covered with an oriented film 19. The oriented film 19 is preferably a vertically oriented film having a pretilt angle to achieve high-speed response. Specifically, such a pretilt angle can be provided by polymer-sustained alignment (PSA), photo-alignment, mask rubbing, or the like. The oriented film 19 is preferably a vertically oriented film having a pretilt angle of, for example, 89.5° or less and has a thickness of, for example, about 0.1 μm. The molecules of the oriented film 19 with such a pretilt angle are tilted, for example, in the direction 45° with respect to the signal line 7.

The counter substrate 21 is disposed so as to face the pixel electrode 11 formed on the substrate 3. A black matrix 23 and color filters 25r, 25g, and 25b are formed on the surface of the counter substrate 21 that faces the pixel electrode 11, and a common electrode 27 that is common to all the pixels is formed on the color filters 25r, 25g, and 25b.

The black matrix 23 is disposed so as to face and cover a region between the sub-pixels 10a and 10b in horizontal and vertical directions. The openings defined by the black matrix 23 are substantially pixel openings. The black matrix 23 preferably completely covers the scanning line 5, the signal line 7, and the common line 9. The color filters 25r, 25g, and 25b are formed in an array so as to correspond to the pixel portions defined by the black matrix 23.

The common electrode 27 is covered with an oriented film 29. The oriented film 29 is also preferably a vertically oriented film having a pretilt angle as with the oriented film 19 formed on the substrate 3 side. The molecules of the oriented film 29 with such a pretilt angle are tilted in the direction antiparallel to the direction in which the molecules of the oriented film 19 are tilted.

The liquid crystal layer LC is disposed between the oriented film 19 on the substrate 3 and the oriented film 29 on the counter substrate 21. The liquid crystal layer LC contains liquid crystal molecules m driven in response to On and Off of the pixel electrode 11. The liquid crystal molecules m are negative liquid crystal molecules (e.g., Δn=0.8 and Δε=−3) having negative dielectric anisotropy.

The substrate 3 and the counter substrate 21 that sandwich the liquid crystal layer LC are maintained at a certain distance (cell gap) from each other by, for example, inserting a pillar-shaped spacer 31 therebetween. Herein, the cell gap is adjusted so that the liquid crystal layer LC has a phase difference of about λ/2 (λ/4 when a reflection type is used) while the liquid crystal molecules m are oriented such that the major axis of the molecules m is aligned in the direction in which electrode portions extend. In this case, the cell gap is adjusted by disposing the pillar-shaped spacer 31 made of a resist material or the like with a height of 4 μm.

A pair of polarizing plates (not shown) are disposed outside the substrate 3 and the counter substrate 21 in a cross nicol state, and a backlight (not shown) is disposed outside the polarizing plate on the substrate 3 side. Thus, a liquid crystal display device 1 is formed.

Such a liquid crystal display device 1 has a structure in which the pixel electrode 11 and the common electrode 27 are disposed so as to face each other and sandwich the liquid crystal layer LC, and the liquid crystal layer LC is driven with a vertical electric field generated between the pixel electrode 11 and the common electrode 27. The pixel electrode 11 is driven with the scanning line 5, the signal line 7, the common line 9, and the pixel circuit having the thin film transistor Tr, all of which are disposed on the substrate 3 side with respect to the pixel electrode 11 with the insulating film 17 therebetween.

The above-described display device 1 according to an embodiment of the present invention is a VA-mode liquid crystal display device whose liquid crystal molecules m are oriented in the direction substantially vertical to the surface of the substrate 3 in accordance with the pretilt angles of the oriented films 19 and 29 when a voltage is not applied to the pixel electrode 11. When a voltage is not applied, light emitted from the backlight disposed outside the substrate 3 is absorbed with the polarizing plate on the counter substrate 21 side and thus a black color is displayed.

The pixel electrode 11 has a structure in which a plurality of electrode portions are arranged in parallel as described below. Therefore, when a voltage is applied to the pixel electrode 11, the liquid crystal molecules m having negative dielectric anisotropy turn sideways in four directions in which the electrode portions extend. Thus, the liquid crystal molecules m are oriented while the major axis of the molecules m is aligned in the direction in which the electrode portions extend, which provides a phase difference of about λ/2 to the liquid crystal layer LC. Consequently, a white color is displayed. Herein, since the liquid crystal molecules m constitute a multi-domain structure in which liquid crystal molecules are oriented in four different directions, the viewing angle characteristics are improved.

Different voltages are applied to the two sub-pixels 10a and 10b disposed in the single pixel unit 10, and the gradation of the single pixel unit 10 is expressed using the two sub-pixels 10a and 10b. For example, a VT (voltage-transmittance) characteristic with a threshold lower than that of the sub-pixel 10b is imparted to the sub-pixel 10a. Furthermore, the threshold voltage and the areas of the sub-pixels 10a and 10b are adjusted to improve the viewing angle characteristics when obliquely viewed. As the gradation value of the pixel displayed is increased, the brightness of the sub-pixel 10a is increased prior to that of the sub-pixel 10b. After the brightness of the sub-pixel 10a is maximized, the brightness of the sub-pixel 10b starts to increase. By including the two sub-pixels 10a and 10b in the single pixel unit 10, the change in y characteristic (gradation-brightness characteristic) when the pixel is obliquely viewed is distributed between the two sub-pixels 10a and 10b. Thus, the change in brightness when the pixel is viewed obliquely or from the front is suppressed.

### 2. Configuration of Pixel Unit

### First Configuration Example

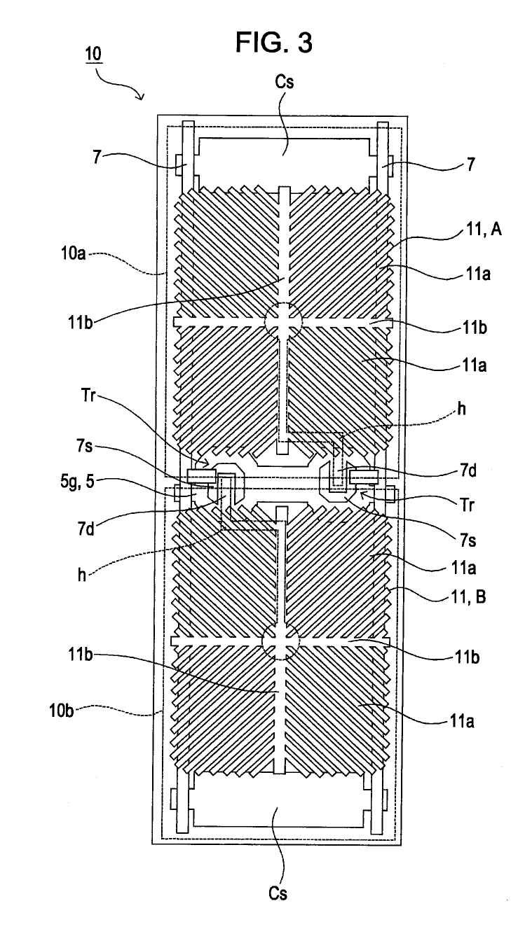

FIG. 3 is a schematic plan view for describing a first configuration example of a pixel unit of a display device according to an embodiment of the present invention. FIG. 3 shows a planar structure of a single pixel unit 10. The pixel unit 10 includes two signal lines 7 arranged to extend in the vertical direction of the drawing and two sub-pixels 10a and 10b that are arranged between the two signal lines 7 and are adjacent to each other in the vertical direction of the drawing. An A electrode serving as a pixel electrode 11 is disposed in the sub-pixel 10a located on the upper side and a B electrode also serving as a pixel electrode 11 is disposed in the sub-pixel 10b located on the lower side.

A scanning line 5 electrically connected to a gate electrode 5g is disposed between the A electrode and the B electrode. That is, the pixel unit 10 includes the scanning line 5 in the center thereof, and the A electrode and the B electrode are respectively disposed on the upper side and the lower side with respect to the scanning line 5.

The A electrode and the B electrode each include a plurality of electrode portions 11a. The A electrode and the B electrode are each divided into four regions (domains), namely upper right, lower right, upper left, and lower left, using, as a boundary, a cross-shaped central electrode portion 11b disposed in the center thereof. The plurality of electrode portions 11a that extend in the same oblique direction are arranged in each of the domains. In other words, in the upper-right domain, the plurality of electrode portions 11a are arranged so as to extend obliquely to the upper right of the domain from the central electrode portion 11b. In the lower-right domain, the plurality of electrode portions 11a are arranged so as to extend obliquely to the lower right of the domain from the central electrode portion 11b. In the upper-left domain, the plurality of electrode portions 11a are arranged so as to extend obliquely to the upper left of the domain from the central electrode portion 11b. In the lower-left domain, the plurality of electrode portions 11a are arranged so as to extend obliquely to the lower left of the domain from the central electrode portion 11b.

With such a pixel electrode 11, the viewing angle characteristics of a VA-mode liquid crystal display device can be improved. That is, when a voltage is applied to liquid crystal having negative dielectric anisotropy, the liquid crystal molecules turn sideways in multiple directions (directions 45° with respect to the absorption axis of a polarizing plate in a cross nicol state) in the domains because of the arrangement of the electrode portions 11a. The liquid crystal molecules are oriented in four directions in which the electrode portions 11a in the domains extend so as to face the center of the cross-shaped central electrode portion 11b.

With the arrangement of the electrode portions 11a, a decrease in transmittance at the boundaries between the domains can be minimized, which achieves high transmittance. Herein, the areas of the multiple domains are necessary to be equalized to maintain uniform viewing angles. In an embodiment of the present invention, the sub-pixels 10a and 10b are respectively disposed on the upper side and the lower side with respect to the scanning line 5, whereby the uniformity of the multi-domain alignment with the A electrode and the B electrode can be easily maintained.

Two thin film transistors Tr serving as selecting devices are disposed on the scanning line 5. Each of the thin film transistors Tr includes a gate electrode 5g, a source electrode 7s, and a drain electrode 7d. The gate electrodes 5g of the thin film transistors Tr are connected to the scanning line 5 common to the two thin film transistors Tr.

The source electrode 7s included in one of the thin film transistors Tr is electrically connected to one of the signal lines 7 and the source electrode 7s included in the other of the thin film transistors Tr is electrically connected to the other of the signal lines 7. The drain electrode 7d included in one of the thin film transistors Tr is electrically connected to the A electrode and the drain electrode 7d included in the other of the thin film transistors Tr is electrically connected to the B electrode. To connect the drain electrodes 7d to the A electrode and the B electrode, a wiring line h is used. The wiring line h is formed in the same layer (the second layer) as the drain electrode 7d.

In the example shown in FIG. 3, the wiring line h is routed from the drain electrode 7d of the thin film transistor Tr on the right side of the drawing to the center of the cross-shaped central electrode portion 11b of the pixel electrode 11 that is the A electrode. The wiring line h is also routed from the drain electrode 7d of the thin film transistor Tr on the left side of the drawing to the center of the cross-shaped central electrode portion 11b of the pixel electrode 11 that is the B electrode.

The wiring line h routed to the A electrode extends in the upward direction of the drawing, extends in the leftward direction, and then extends to the center of the cross along the part of the central electrode portion 11b that extends in the vertical direction of the drawing. The wiring line h is brought into contact with the A electrode at the center of the cross-shaped central electrode portion 11b.

The wiring line h routed to the B electrode extends in the downward direction of the drawing, extends in the rightward direction, and then extends to the center of the cross along the part of the central electrode portion 11b that extends in the vertical direction of the drawing. The wiring line h is brought into contact with the B electrode at the center of the cross-shaped central electrode portion 11b.

To realize the layout of such wiring lines h, the source electrodes 7s of the two thin film transistors Tr are disposed so as to open in directions opposite to each other. That is, the source electrode 7s of the right-side thin film transistor Tr opens upward, and the drain electrode 7d and the wiring line h extend from the opening in the upward direction of the drawing. On the other hand, the source electrode 7s of the left-side thin film transistor Tr opens downward, and the drain electrode 7d and the wiring line h extend from the opening in the downward direction of the drawing.

In an embodiment of the present invention, a pair of polarizing plates are disposed in a cross nicol state, and the vertical direction and the horizontal direction of the drawing are directions of transmission axes or absorption axes of the polarizing plates. The wiring lines h shown in FIG. 3 each include a portion that extends in the transmission axis direction or the absorption axis direction of the polarizing plates, outside a region where the scanning line 5 is disposed or a light-shielding film that covers the scanning line 5 is formed.

The wiring line h also includes a portion disposed along the boundary of the four domains of the pixel unit 10. The wiring line h shown in FIG. 3 includes a portion that extends in the vertical direction of the drawing on the scanning line 5 and a portion that extends along the boundary of the domains which are located outside the region where the scanning line 5 is disposed and the light-shielding film is formed, that is, a portion that extends along the part of the central electrode portion 11b which extends in the vertical direction. Thus, liquid crystal around the wiring lines h is oriented in the transmission axis direction or the absorption axis direction of the polarizing plates, which can suppress light leakage.

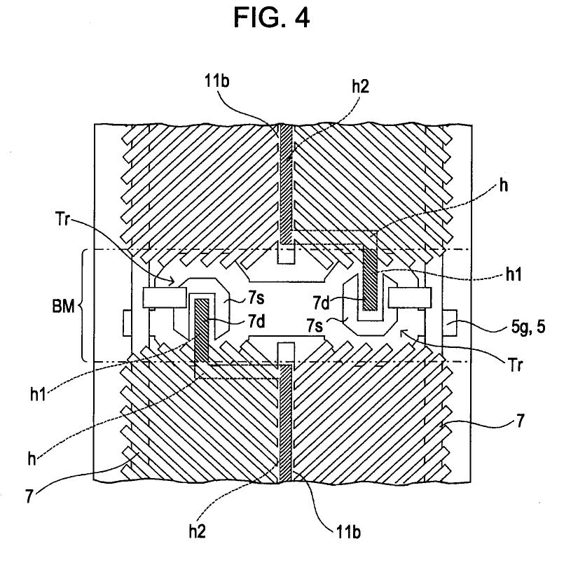

FIG. 4 is a partially enlarged view of a central portion of the first configuration example. A black matrix BM that is a light-shielding film is disposed on the scanning line 5 formed in the center of the pixel unit 10. The thin film transistors Tr on the scanning line 5 are also shielded from light by the black matrix BM. The wiring lines h according to an embodiment of the present invention each extend from the drain electrode 7d of the thin film transistor Tr, and include a portion h1 that extends in the transmission axis direction or the absorption axis direction (the vertical direction of the drawing) of the polarizing plates in the region covered with the black matrix BM.

The wiring line h extends in the horizontal direction of the drawing from the portion h1 and then extends in the vertical direction of the drawing when the wiring line h reaches the central electrode portion 11b. The portion h2 that extends along the central electrode portion 11b in the vertical direction is a boundary line of the four domains of the pixel unit 10. Thus, the liquid crystal around the wiring line h is oriented in the transmission axis direction or the absorption axis direction of the polarizing plates, which can suppress light leakage.

In the first configuration example, the aperture ratio can be increased by about 10% compared with the configuration in which wiring lines are routed to the A electrode and the B electrode from the scanning line 5 located at the end of the pixel unit 10.

In the display device according to an embodiment of the present invention, polymer dispersed polyimide (PDPI) treatment is preferably performed to improve the response speed. In the PDPI treatment, a pretilt is provided by mixing a photopolymerizable monomer in an oriented film and then irradiating the mixture with ultraviolet rays while a voltage is applied, to allow the reaction of the monomer in the oriented film to occur. Alternatively, polymer-sustained alignment (PSA) treatment may be performed. In the PSA treatment, a pretilt is provided by mixing a photopolymerizable monomer in liquid crystal and then irradiating the mixture with ultraviolet rays while a voltage is applied, to allow the reaction of the monomer in the liquid crystal to occur.

### Second Configuration Example

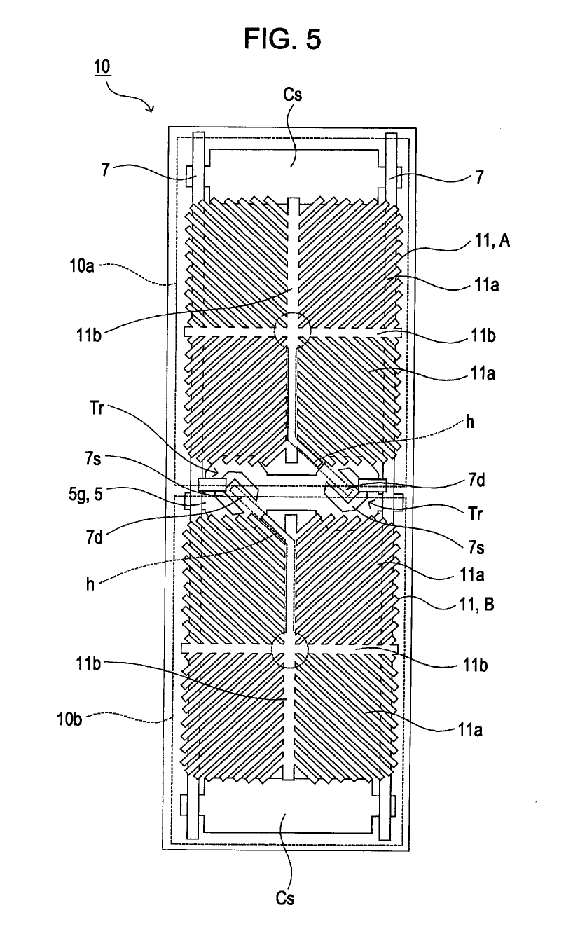

FIG. 5 is a schematic plan view for describing a second configuration example of a pixel unit of a display device according to an embodiment of the present invention. FIG. 5 shows a planar structure of a single pixel unit 10. The pixel unit 10 includes two signal lines 7 arranged to extend in the vertical direction of the drawing and two sub-pixels 10a and 10b that are arranged between the two signal lines 7 and are adjacent to each other in the vertical direction of the drawing. An A electrode serving as a pixel electrode 11 is disposed in the sub-pixel 10a located on the upper side and a B electrode also serving as a pixel electrode 11 is disposed in the sub-pixel 10b located on the lower side.

A scanning line 5 electrically connected to a gate electrode 5g is disposed between the A electrode and the B electrode. That is, the pixel unit 10 includes the scanning line 5 in the center thereof, and the A electrode and the B electrode are respectively disposed on the upper side and the lower side with respect to the scanning line 5.

The A electrode and the B electrode each include a plurality of electrode portions 11a. The A electrode and the B electrode are each divided into four regions (domains), namely upper right, lower right, upper left, and lower left, using, as a boundary, a cross-shaped central electrode portion 11b disposed in the center thereof. The plurality of electrode portions 11a that extend in the same oblique direction are arranged in each of the domains. In other words, in the upper-right domain, the plurality of electrode portions 11a are arranged so as to extend obliquely to the upper right of the domain from the central electrode portion 11b. In the lower-right domain, the plurality of electrode portions 11a are arranged so as to extend obliquely to the lower right of the domain from the central electrode portion 11b. In the upper-left domain, the plurality of electrode portions 11a are arranged so as to extend obliquely to the upper left of the domain from the central electrode portion 11b. In the lower-left domain, the plurality of electrode portions 11a are arranged so as to extend obliquely to the lower left of the domain from the central electrode portion 11b.

With such a pixel electrode 11, the viewing angle characteristics of a VA-mode liquid crystal display device can be improved. That is, when a voltage is applied to liquid crystal having negative dielectric anisotropy, the liquid crystal molecules turn sideways in multiple directions (directions 45° with respect to the absorption axis of a polarizing plate in a cross nicol state) in the domains because of the arrangement of the electrode portions 11a. The liquid crystal molecules are oriented in four directions in which the electrode portions 11a of each of the domains extend so as to face the center of the cross-shaped central electrode portion 11b.

With the arrangement of the electrode portions 11a, a decrease in transmittance at the boundaries between the domains can be minimized, which achieves high transmittance. Herein, the areas of the multiple domains are necessary to be equalized to maintain uniform viewing angles. In an embodiment of the present invention, the sub-pixels 10a and 10b are respectively disposed on the upper side and the lower side with respect to the scanning line 5, whereby the uniformity of the multi-domain alignment with the A electrode and the B electrode can be easily maintained.

Two thin film transistors Tr serving as selecting devices are disposed on the scanning line 5. Each of the thin film transistors Tr includes a gate electrode 5g, a source electrode 7s, and a drain electrode 7d. The gate electrodes 5g of the thin film transistors Tr are connected to the scanning line 5 common to the two thin film transistors Tr.

The source electrode 7s included in one of the thin film transistors Tr is electrically connected to one of the signal lines 7 and the source electrode 7s included in the other of the thin film transistors Tr is electrically connected to the other of the signal lines 7. The drain electrode 7d included in one of the thin film transistors Tr is electrically connected to the A electrode and the drain electrode 7d included in the other of the thin film transistors Tr is electrically connected to the B electrode. To connect the drain electrodes 7d to the A electrode and the B electrode, a wiring line h is used. The wiring line h is formed in the same layer (the second layer) as the drain electrode 7d.

In the example shown in FIG. 5, the wiring line h is routed from the drain electrode 7d of the thin film transistor Tr on the right side of the drawing to the center of the cross-shaped central electrode portion 11b of the pixel electrode 11 that is the A electrode. The wiring line h is also routed from the drain electrode 7d of the thin film transistor Tr on the left side of the drawing to the center of the cross-shaped central electrode portion 11b of the pixel electrode 11 that is the B electrode.

The wiring line h routed to the A electrode extends obliquely in the upper-left direction of the drawing and then extends to the center of the cross along the part of the central electrode portion 11b that extends in the vertical direction of the drawing. The wiring line h is brought into contact with the A electrode at the center of the cross-shaped central electrode portion 11b.

The wiring line h routed to the B electrode extends obliquely in the lower-right direction of the drawing and then extends to the center of the cross along the part of the central electrode portion 11b that extends in the vertical direction of the drawing. The wiring line h is brought into contact with the B electrode at the center of the cross-shaped central electrode portion 11b.

To realize the layout of such wiring lines h, the source electrodes 7s of the two thin film transistors Tr are disposed so as to open in directions opposite to each other. That is, the source electrode 7s of the right-side thin film transistor Tr opens obliquely in the upper-left direction, and the drain electrode 7d and the wiring line h extend from the opening obliquely in the upper-left direction of the drawing. On the other hand, the source electrode 7s of the left-side thin film transistor Tr opens obliquely in the lower-right direction, and the drain electrode 7d and the wiring line h extend from the opening obliquely in the lower-right direction of the drawing.

In an embodiment of the present invention, a pair of polarizing plates are disposed in a cross nicol state, and the vertical direction and the horizontal direction of the drawing are directions of transmission axes or absorption axes of the polarizing plates. The wiring lines h shown in FIG. 5 each include a portion that extends in the direction different from the transmission axis direction or the absorption axis direction of the polarizing plates, in a region where the scanning line 5 is disposed or a light-shielding film that covers the scanning line 5 is formed.

The wiring line h also includes a portion disposed along the boundary of the four domains of the pixel unit 10. The wiring line h shown in FIG. 5 includes a portion that extends in the oblique direction of the drawing on the scanning line 5 and a portion that extends along the part of the central electrode portion 11b which extends in the vertical direction, the part being the boundary of the domains. Thus, the wiring line h is shortened in the portion that extends in the oblique direction compared with the case of the wiring line shown in FIG. 3, which decreases parasitic capacitance. Furthermore, liquid crystal around the wiring lines h is oriented in the transmission axis direction or the absorption axis direction of the polarizing plates in the portion where the wiring line h extends in the vertical direction, which can suppress light leakage.

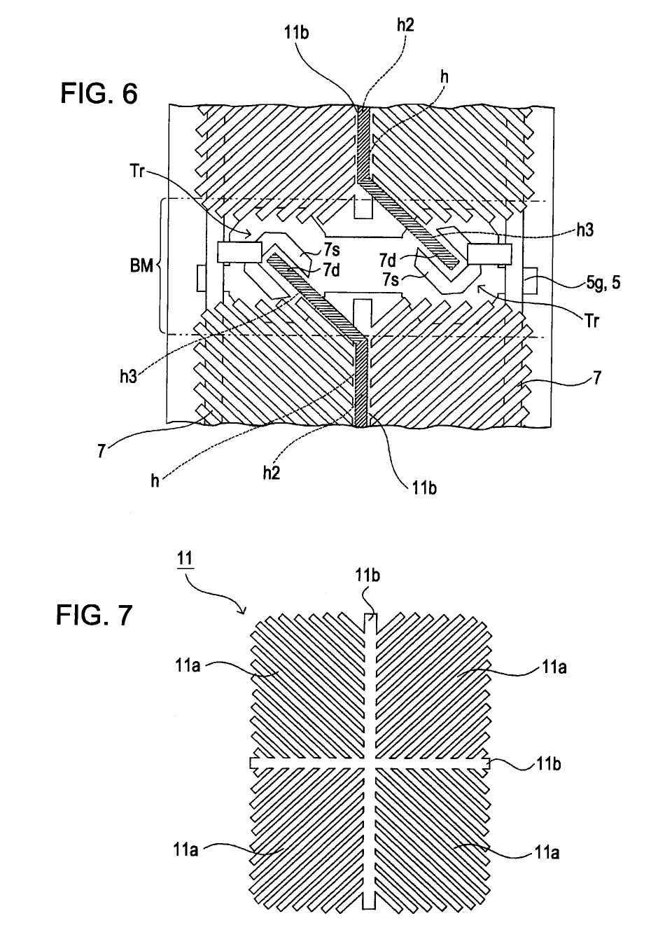

FIG. 6 is a partially enlarged view of a central portion of the second configuration example. A black matrix BM that is a light-shielding film is disposed on the scanning line 5 formed in the center of the pixel unit 10. The thin film transistors Tr on the scanning line 5 are also shielded from light by the black matrix BM. The wiring lines h according to an embodiment of the present invention each extend from the drain electrode 7d of the thin film transistor Tr, and include a portion h3 that extends in the direction (the oblique direction of the drawing) different from the transmission axis direction or the absorption axis direction of the polarizing plates in the region covered with the black matrix BM.

The wiring line h extends in the vertical direction of the drawing from a position at which the portion h3 reaches the central electrode portion 11b. The portion h2 that extends along the central electrode portion 11b in the vertical direction is a boundary line of the four domains of the pixel unit 10. Thus, the liquid crystal around the wiring line h is oriented in the transmission axis direction or the absorption axis direction of the polarizing plates, which can suppress light leakage.

In the second configuration example, the parasitic capacitance Cgd generated by the gate electrode and the drain electrode can be suppressed while the aperture ratio can be increased by about 15% compared with the configuration in which wiring lines are routed to the A electrode and the B electrode from the scanning line 5 located at the end of the pixel unit 10. Transmittance affected by the disturbance of orientation due to the wiring lines from the drain electrode is also improved. Furthermore, the parasitic capacitance Cgd between the gate electrode and the drain electrode is suppressed, which also suppresses flicker.

In the display device according to an embodiment of the present invention, polymer dispersed polyimide (PDPI) treatment is preferably performed to improve the response speed. In the PDPI treatment, a pretilt is provided by mixing a photopolymerizable monomer in an oriented film and then irradiating the mixture with ultraviolet rays while a voltage is applied, to allow the reaction of the monomer in the oriented film to occur. Alternatively, polymer-sustained alignment (PSA) treatment may be performed. In the PSA treatment, a pretilt is provided by mixing a photopolymerizable monomer in liquid crystal and then irradiating the mixture with ultraviolet rays while a voltage is applied, to allow the reaction of the monomer in the liquid crystal to occur.

### 3. Other Examples of Pixel Electrode

There are various configurations of pixel electrodes that are the A electrode and the B electrode. FIG. 7 shows the configuration of the pixel electrode shown in the configuration examples of the pixel units shown in FIGS. 3 and 5. In FIG. 7, a plurality of electrode portions 11a extend from a cross-shaped central electrode portion 11b at an angle determined for each domain.

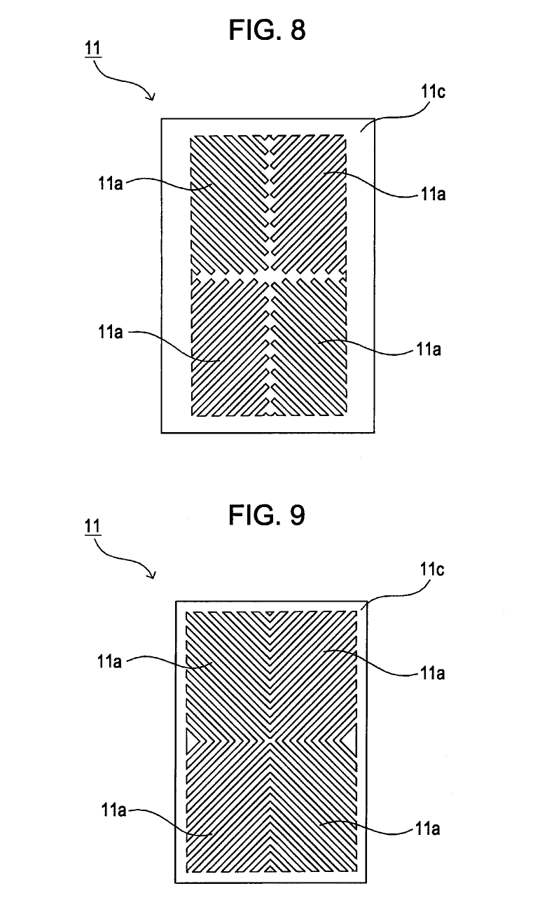

In FIG. 8, a frame-shaped electrode portion 11c is disposed so as to surround the periphery of sub-pixels, and a plurality of electrode portions 11a extend in oblique directions from each of the corners of the frame-shaped electrode portion 11c to the center. The plurality of electrode portions 11a that extend from each of the corners of the frame-shaped electrode portion 11c are arranged at the same oblique angle determined for each of the corners. A cross-shaped gap is formed in a central portion, which provides four domains corresponding to the corners. The frame-shaped electrode portion 11c has an effect of shielding the signal line and the common line and thus display characteristics with high contrast can be achieved.

In FIG. 9, a frame-shaped electrode portion 11c is disposed so as to surround the periphery of sub-pixels, and a plurality of electrode portions 11a extend from each of the corners of the frame-shaped electrode portion 11c to the center. The plurality of electrode portions 11a that extend from each of the corners of the frame-shaped electrode portion 11c are connected to each other in a central portion. The plurality of electrode portions 11a are arranged at the same oblique angle determined for each of the corners, which provides four domains corresponding to the corners. The frame-shaped electrode portion 11c has an effect of shielding the signal line and the common line and thus display characteristics with high contrast can be achieved.

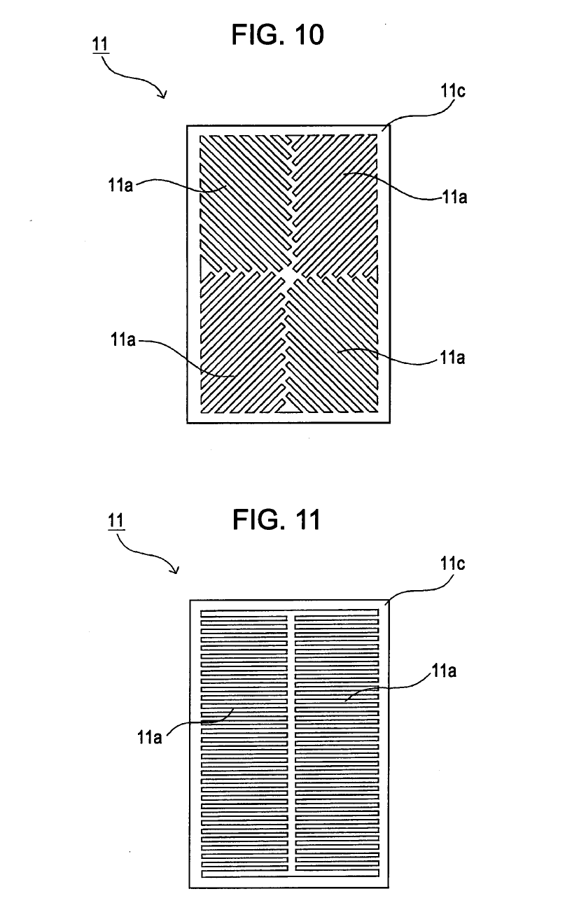

In FIG. 10, a frame-shaped electrode portion 11c is disposed so as to surround the periphery of sub-pixels, and a plurality of electrode portions 11a extend from each of the corners of the frame-shaped electrode portion 11c to the center in oblique directions. The plurality of electrode portions 11a that extend from each of the corners of the frame-shaped electrode portion 11c are arranged at the same oblique angle determined for each of the corners. The electrode portions 11a that extend from one of the corners are arranged so as to be staggered by half a pitch from the electrode portions 11a that extend from the adjacent corner. A cross-shaped gap is formed in a central portion, which provides four domains corresponding to the corners. The frame-shaped electrode portion 11c has an effect of shielding the signal line and the common line and thus display characteristics with high contrast can be achieved.

In FIG. 11, a frame-shaped electrode portion 11c is disposed so as to surround the periphery of sub-pixels, and a plurality of electrode portions 11a extend in the horizontal direction of the drawing from the left and right vertical frame portions of the frame-shaped electrode portion 11c to the center. A gap that extends in the vertical direction of the drawing is formed in the central portion of the frame-shaped electrode portion 11c, which provides left and right domains separated by the gap. The frame-shaped electrode portion 11c has an effect of shielding the signal line and the common line and thus display characteristics with high contrast can be achieved.

In FIG. 12, a frame-shaped electrode portion 11c is disposed so as to surround the periphery of sub-pixels, and a plurality of electrode portions 11a that extend in the same oblique direction are arranged inside the frame-shaped electrode portion 11c. In this example, the electrode portions 11a are obliquely arranged, for example, at an angle of 45° relative to the scanning line or the signal line. This provides a monodomain structure in which liquid crystal is oriented in the direction in which the electrode portions 11a extend. The frame-shaped electrode portion 11c has an effect of shielding the signal line and the common line and thus display characteristics with high contrast can be achieved.

In FIG. 13, a frame-shaped electrode portion 11c is disposed so as to surround the periphery of sub-pixels, and a plurality of electrode portions 11a extend in the horizontal direction of the drawing from the left and right vertical frame portions of the frame-shaped electrode portion 11c to the center. A gap that extends in the vertical direction of the drawing is formed in the central portion of the frame-shaped electrode portion 11c, which provides left and right domains separated by the gap. In the example shown in FIG. 13, a pad that contacts a wire line electrically connected to the drain electrode is disposed in the central portion of the frame-shaped electrode portion 11c. The frame-shaped electrode portion 11c has an effect of shielding the signal line and the common line and thus display characteristics with high contrast can be achieved.

The display device according to an embodiment of the present invention is not limited to the above-described configurations of pixel electrodes, and other configurations can be applied.

In the above-described display device according to an embodiment of the present invention, an example in which a single pixel unit 10 includes two sub-pixels 10a and 10b has been mainly described. However, a single pixel unit may include three or more sub-pixels. In the case where three or more sub-pixels are disposed, the configuration according to an embodiment of the present invention can be applied to at least a pair of adjacent sub-pixels.

### 4. Examples of Electronic Apparatus

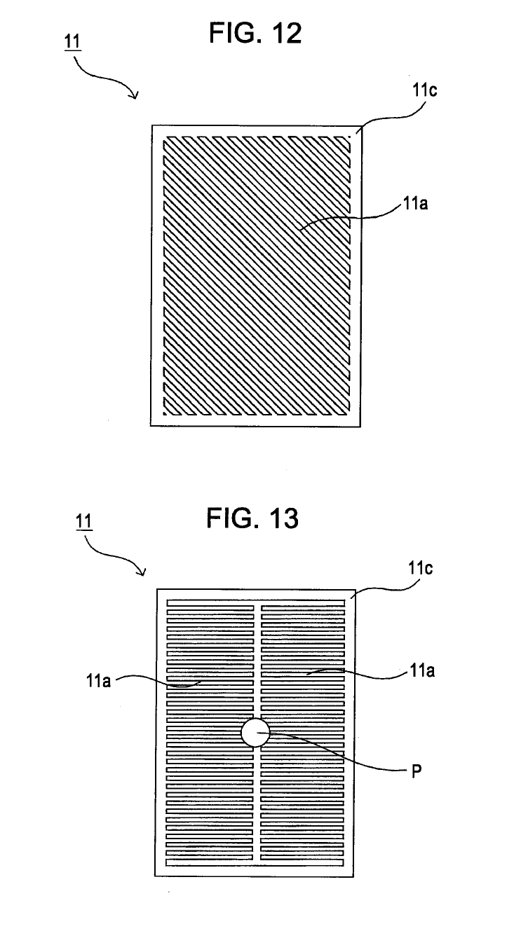

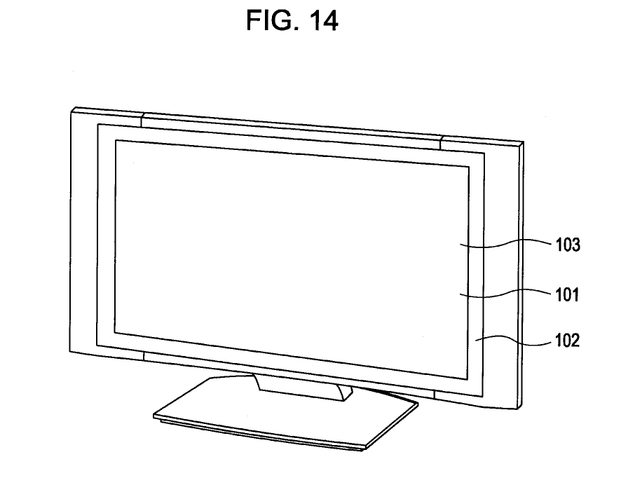

The above-described display device (e.g., liquid crystal display device) according to an embodiment of the present invention can be used, as a display panel, for a display unit of various electronic apparatuses shown in FIGS. 14 to 18. For example, the above-described display device can be applied to a display unit of an electronic apparatus in various fields that displays, as a picture or video image, video signals input to the electronic apparatus or video signals generated in the electronic apparatus. Examples of the electronic apparatus include digital cameras, notebook personal computers, mobile terminal apparatuses such as cellular phones, and video cameras. The display device according to an embodiment of the present invention is installed in a casing of various electronic apparatuses. Some of the electronic apparatuses to which an embodiment of the present invention is applied will now described.

FIG. 14 is a perspective view of a television to which an embodiment of the present invention is applied. The television according to this application example includes an image display screen 101 composed of a front panel 102, a filter glass 103, and the like, and can be produced by employing the display device according to an embodiment of the present invention as the image display screen 101.

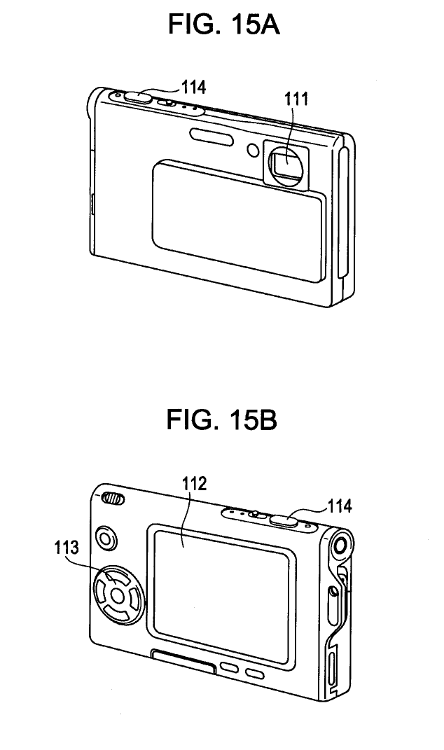

FIG. 15A is a perspective view of a digital camera to which an embodiment of the present invention is applied, the digital camera being viewed from the front side. FIG. 15B is a perspective view of the digital camera viewed from the rear side. The digital camera according to this application example includes a light-emitting unit 111 for flashlight, a display unit 112, a menu switch 113, a shutter button 114, and the like, and can be produced by employing the display device according to an embodiment of the present invention as the display unit 112.

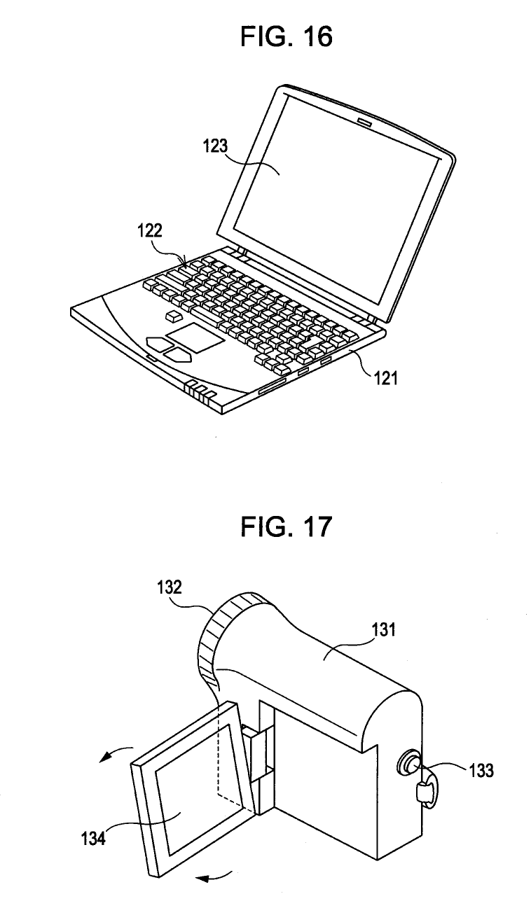

FIG. 16 is a perspective view of a notebook personal computer to which an embodiment of the present invention is applied. The notebook personal computer according to this application example includes a main body 121, a keyboard 122 that is operated when characters and the like are input to the main body, and a display unit 123 configured to display images, and can be produced by employing the display device according to an embodiment of the present invention as the display unit 123.

FIG. 17 is a perspective view of a video camera to which an embodiment of the present invention is applied. The video camera according to this application example includes a main body 131, a lens 132 for shooting an object, the lens being disposed on a front side face, a start/stop switch 133 used in shooting, a display unit 134, and the like, and can be produced by employing the display device according to an embodiment of the present invention as the display unit 134.

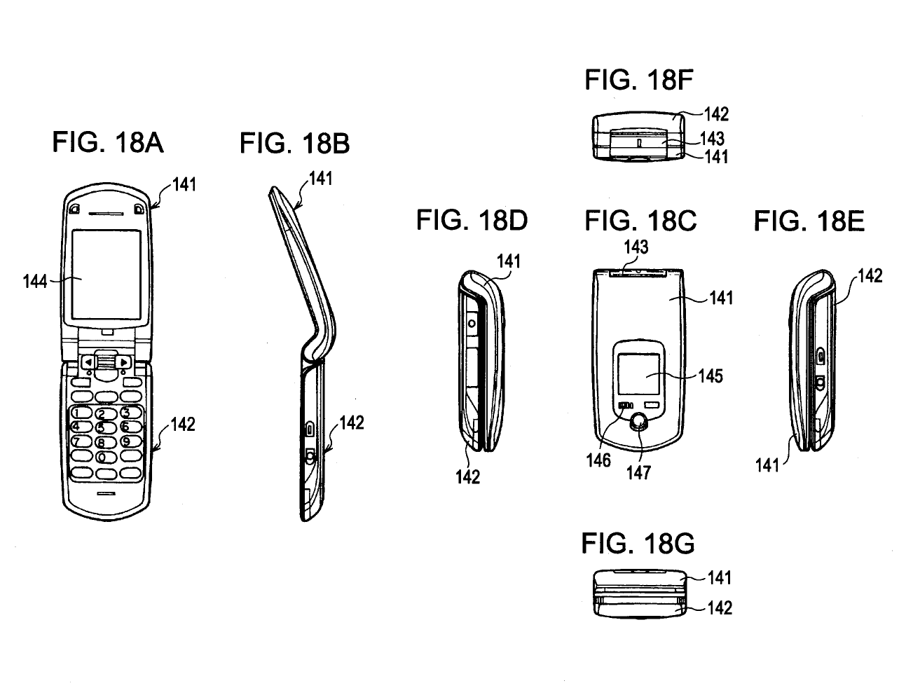

FIGS. 18A to 18G are diagrams showing a mobile terminal apparatus such as a cellular phone to which an embodiment of the present invention is applied. FIG. 8A is a front view of the cellular phone in an opened state, FIG. 8B is a side view thereof, FIG. 8C is a front view of the cellular phone in a closed state, FIG. 8D is a left side view thereof, FIG. 8E is a right side view thereof, FIG. 8F is a top view thereof, and FIG. 8G is a bottom view thereof. The cellular phone according to this application example includes an upper casing 141, a lower casing 142, a connecting portion (hinge in this example) 143, a display unit 144, a sub-display unit 145, a picture light 146, a camera 147, and the like, and can be produced by employing the display device according to an embodiment of the present invention as the display unit 144 or the sub-display unit 145.

The present application contains subject matter related to that disclosed in Japanese Priority Patent Application JP 2009-173899 filed in the Japan Patent Office on Jul. 27, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a pixel unit including a plurality of sub-pixels;
a plurality of pixel electrodes disposed in the pixel unit so as to correspond to the plurality of sub-pixels;
a scanning line disposed at a position between two adjacent pixel electrodes of the plurality of pixel electrodes; and
two selecting devices configured to select whether a signal is supplied to the respective two pixel electrodes, the selecting devices being disposed on the scanning line.

2. The display device according to claim 1, further comprising:
wiring lines routed from the two selecting devices to the substantially central portions of the respective pixel electrodes.

3. The display device according to claim 1,
wherein the two selecting devices each include a gate electrode, a source electrode, and a drain electrode,
the gate electrodes of the two selecting devices are connected to the scanning line,
the source electrodes of the two selecting devices are connected to respective signal lines, and
the drain electrodes of the two selecting devices are connected to wiring lines routed to the substantially central portions of the respective pixel electrodes.

4. The display device according to claim 2 or 3,
wherein the pixel electrodes are configured to drive a liquid crystal, and
the wiring lines each include a portion that extends in a direction different from a transmission axis direction or an absorption axis direction of a polarizing plate of the liquid crystal, in a region where the scanning line is disposed or a light-shielding film is formed.

5. The display device according to claim 4, wherein the wiring lines each include a portion that extends in the transmission axis direction or the absorption axis direction of the polarizing plate of the liquid crystal, outside the region where the scanning line is disposed or the light-shielding film is formed.

6. The display device according to claim 5, wherein the wiring lines each include a portion that extends in the transmission axis direction or the absorption axis direction of the polarizing plate of the liquid crystal, and the portion extends along a boundary between domains of liquid crystal orientation in the pixel unit.

7. The display device according to claim 2 or 3,
wherein the pixel electrodes are configured to drive a liquid crystal, and
the wiring lines each include a portion that extends in a transmission axis direction or an absorption axis direction of a polarizing plate of the liquid crystal, and the portion extends along a boundary between domains of liquid crystal orientation in the pixel unit.

8. The display device according to claim 7, wherein a plurality of the domains are disposed for each of the pixel electrodes.

9. An electronic apparatus comprising:
a casing; and
a display device installed in the casing,
wherein the display device includes
a pixel unit including a plurality of sub-pixels;
a plurality of pixel electrodes disposed in the pixel unit so as to correspond to the plurality of sub-pixels;
a scanning line disposed at a position between two adjacent pixel electrodes of the plurality of pixel electrodes; and
two selecting devices configured to select whether a signal is supplied to the respective two pixel electrodes, the selecting devices being disposed on the scanning line.
